(19) United States
(12) Patent Application Publication
(10) Pub. No.: US 2014/0261243 A1
(43) Pub. Date: Sep. 18, 2014

(54) TURBINE THERMAL GENERATOR AND CONTROLLER

(71) Applicant: ADVANCED TECHNOLOGY APPLICATIONS, LLC, MORGANTOWN, WV (US)

(72) Inventors: Carl Bickel, Pittsburgh, PA (US); Justin R. Chambers, Glen Dale, WV (US); Franz A. Pertl, Morgantown, WV (US); Brian Rampolla, Pittsburgh, PA (US); Tom A. Risley, Jefferson Hills, PA (US); James E. Smith, Bruceton Mills, WV (US)

(73) Assignee: ADVANCED TECHNOLOGY APPLICATIONS, LLC, MORGANTOWN, WV (US)

(21) Appl. No.: 14/216,671

(22) Filed: Mar. 17, 2014

Related U.S. Application Data
(60) Provisional application No. 61/787,637, filed on Mar. 15, 2013.

(51) Int. Cl. F03D 9/00; F24J 3/00

(52) U.S. Cl. CPC F03D 9/006; F24J 3/003
USPC 122/26; 126/246; 432/49

(57) ABSTRACT

A turbine thermal generator and controller includes first and second members having opposing surfaces together defining boundaries of a fluid chamber, a means for rotating about an axis said first member relative to said second member thereby generating heat in a fluid contained in said fluid chamber, and means for transferring heat from said fluid to a load.

### RELATED APPLICATION DATA

This application claims the benefit of U.S. Provisional Application No. 61/787,637, filed Mar. 15, 2013, which is incorporated herein by reference in its entirety to provide continuity of disclosure.

### TECHNICAL FIELD

The present application relates generally to a thermal generator and controller, and more particularly to a turbine thermal generator and controller.

### BACKGROUND

There are estimates that offsetting 50% of the potential energy consumption to heat water for the average family home would create a savings of about $300 a year per household. Studies have shown that if a small percentage of households in the United States, for example, could offset their hot water heating energy consumption, the reduction in energy consumption nationally would total more than 270 trillion British Thermal Units, or an equivalent of 2.4 billion gallons of gasoline. However, currently available wind turbines and other renewable energy systems that require the conversion of the renewable energy into electricity include expensive electric conditioning units that are required to connect into the electrical grid or the electric system of the home or business. Furthermore, these electric conditioning units make the renewable energy systems overly complex for residential and commercial consumers to install and maintain over the useful life of the system.

The aforementioned renewable energy systems having electric conditioning units are not ideal and risk lower adoption rates of renewable energy technology by residential and commercial consumers. Accordingly, a new turbine thermal generator is desired.

### SUMMARY

In one aspect, an apparatus comprising first and second members having opposing surfaces together defining boundaries of a fluid chamber. The apparatus includes means for rotating about an axis said first member relative to said second member thereby generating heat in a fluid contained in said fluid chamber. Further, the apparatus includes means for transferring heat from said fluid to a load.

In accordance with a particular aspect, an apparatus comprising a turbine having an input shaft and an output shaft and first and second members having opposing surfaces together defining boundaries of a fluid chamber. The apparatus includes means for rotating about an axis said first member relative to said second member thereby generating a resistance in a fluid contained in said fluid chamber and a means for transferring said resistance to said turbine as a resisting torque. Further, the apparatus includes a first sensor that senses a rotating speed of said input shaft of said turbine and a second sensor that senses a speed of a motive fluid and means for responding to said sensors by moving said first and second members relative to each other along said axis thereby varying generation of said resisting torque.

In accordance with another aspect, an apparatus comprising first and second members having opposing surfaces together defining boundaries of a fluid chamber and means for moving said first member relative to said second member thereby generating heat in a fluid contained in said fluid chamber. Further, the apparatus includes means for transferring heat from said fluid to a load and a turbine in communication with a motive force.

### BRIEF DESCRIPTION OF THE DRAWINGS

FIG. 1A is a schematic of a thermal generator and controller system.

FIG. 1B is a schematic of an electronic controller.

FIG. 2 is model of a portion of the thermal generator and controller.

FIGS. 3A-3B are exemplary graphs of turbine efficiency curves and power curves.

FIGS. 4A-4C are cross section schematics of exemplary embodiments of a thermal generator and controller.

FIG. 5 is a cross section schematic of an alternative exemplary embodiment of a thermal generator and controller.

FIG. 6 is top view schematic of another alternative exemplary embodiment of a thermal generator and controller.

FIG. 7 is a cross section schematic of yet another alternative exemplary embodiment of a thermal generator and controller.

FIGS. 8A-8F are perspective views of various portions of the exemplary embodiment of the thermal generator and controller illustrated in FIG. 7.

FIG. 9 is a schematic of another thermal generator and controller system.

FIG. 10 is a schematic of a thermal generator and controller.

### DETAILED DESCRIPTION

The following detailed description will illustrate the general principles of the invention, examples of which are additionally illustrated in the accompanying drawings.

FIG. 1A illustrates a schematic of one embodiment illustrating a thermal generator and controller system 100 having a thermal generator and controller 102 securedly connected to output shaft 104 of turbine 106. In the illustrated embodiment, output shaft 104 is configured to rotate when wind or another fluid motivates turbine 106 to rotate. For example only, turbine 106 may be a wind turbine, a turbine in a river or another moving body of water, a gas turbine in an industrial process, or the like. As discussed further herein, thermal generator 102 is based on the following concept where a thermal fluid 108 with a relatively high viscosity and heat absorption and transfer capability is subjected to a shearing action from a moving or rotating surface 110 (for example, a rotating cylinder or drum about an axis, a series of closely spaced plates, concentric cylinders, tapered cylinders, or other suitable surfaces having opposed surfaces). This shearing action from a moving or rotating surface produces a viscous resisting torque and converts the moving or rotating mechanical energy from moving or rotating surface 110 into heat that elevates the temperature of thermal fluid 108 contained in the fluid chamber defined by the boundaries of rotating surface 110 and non-rotating surface 112. In the illustrated embodiment, heat generated by thermal generator 102 is transferred to a load, for example a thermal storage container 114 by a fluid system or heat transfer tubing 116 (e.g., piping, tubing, or the like) where the heat may be stored for use or consumed by a home, business, or the like. The fluid system defines a fluid flow path from thermal generator to the load and from the load to the thermal generator. In another embodiment, fluid system defines a fluid flow path from a heat exchanger that is in heat transfer communication with the thermal generator to the load and from the load to the heat exchanger. In another embodiment, the thermal generator system may include at least one sensor and a control system to vary one or more parameters of the thermal generator and controller system or a component therein.

FIG. 1B is an electronic controller 118 that is operatively associated with the thermal generator and controller system 100 illustrated in FIG. 1A. The electronic controller 118, which may comprise any suitable programmable logic controller or other device, or combination of such control devices, has hardware and/or software configured to operate parts of the thermal generator and controller system 100. The electronic controller is operatively associated with sensors 120, 122, and 124 to variable control the thermal generator and controller system 100. For example, sensor 120 is configured to sense a rotating speed of an input shaft of a turbine 106 and sensor 122 is configured to sense speed of a motive fluid rotating the turbine. In this example, electronic controller is configured to respond to the sensors and move members of the thermal generator and controller 102 relative to one another to vary the generation of resisting torque or heat generation of the thermal generator and controller.

FIG. 2 illustrates a portion of a thermal generator and controller 200 that is modeled as a rotor 202 having a diameter D, rotating at a rotational velocity ω, and with a thermal fluid 204 filling a fluid chamber or gap 206 having a width “a” between opposing surfaces, e.g., rotor 202 and a fixed outer drum 208 or a fixed surface and the like. Shear stress in a fluid can be estimated as fl!J, Txy=Za. Based on the shear stress, the resisting torque on rotor 202 can be calculated as

$$T = \frac{π}{2} {τ}_{xy} {D}^{2} L = \frac{π}{4 a} μ ω {D}^{3} L ,$$

where ll is fluid viscosity, ω is rotor 202 rotational velocity, D is rotor 202 diameter, “a” is the width of the thermal fluid chamber or gap 206, L is the height of rotor 202, T_{xy} is the shear stress in thermal fluid 204, T is the resisting torque on the rotor, and P is the power loss or the equivalent to the heat generated in thermal fluid 204. Based on the resisting torque, the resulting power loss or equivalent heat generated in thermal fluid 204 is calculated as

$$P = T ω = \frac{π}{4 a} {μω}^{2} {D}^{3} L .$$

Thermal generator and controller 200 or a viscous controller is configured to have a resisting torque that generates heat in the thermal fluid for a specified turbine application. For example, selecting a thermal fluid 204 having a higher thermal fluid viscosity ll will provide thermal generator and controller 200 a higher torque and power absorption capability relative to a thermal fluid having a lower thermal fluid viscosity. As described further herein, by actively varying the size of gap 206 by moving the first and second members (for example) relative to one another, the torque, e.g., a resisting torque, and power, e.g., heat generation, of thermal generator and controller 200 can be configured to be actively controlled.

Renewable energy turbines can be characterized by their coefficient of performance, Kₚ, curve by testing turbine performance over a range of fluid speed conditions, e.g., wind speed conditions of a wind turbine. FIG. 3A illustrates a curve representing the efficiency with which a turbine absorbs kinetic energy of the turbine's motive fluid (e.g., wind) and is dependent on the turbine design characteristics, including but not limited to the turbine blade characteristics and their rotational velocity, wr, in relation to the wind speed, VcfJ. The ratio of ωr to V∞ is known as the tip speed ratio A (1/λ). The theoretical upper limit of the ratio of the winds kinetic energy and the energy absorbed by a turbine (e.g., wind turbine) is given by the Betz limit and is approximately 0.6. An example coefficient of performance curve as calculated by momentum model methods is illustrated in FIG. 3A. Note that power absorption is not necessarily constant or smooth as the wind turbine blades rotate and the coefficient of performance Kₚ is determined from a rotational average. This curve illustrated in FIG. 3A together with wind probability distributions can be used to predict increased power generation. The general shape of the instantaneous power absorbed at a fixed turbine rotational speed can be determined by multiplying the coefficient of performance Kₚ curve by x³ which is proportional to fluid speed (e.g., wind speed). The resulting non-dimensional quantity is proportional to power. The thermal generator and controllers discussed herein are configured to generate renewable power and to provide a resisting torque that maintains a turbine at its optimum tip speed ratio.

FIG. 3B is given as an example using the coefficient of performance Kₚ in FIG. 3A where FIG. 3B is an exemplary turbine power curve that illustrates by varying the torque and controlling the turbines' rotational speed in relation to the wind speed, the peak of FIG. 3B can be tracked to maximize power extraction from the turbine. FIG. 3B illustrates that the maximum power generated for a given wind speed does not occur at the maximum wind turbine speed, or the highest wind speed, rather it occurs when the two are properly matched for a given turbine design. Therefore, the amount of viscous resisting torque from the thermal fluid applied to the turbine shaft can be varied to control the turbine speed and power output (e.g., heat generated). So for a given wind speed the wind turbine has an optimum resisting torque (point 300 on FIG. 3B), which will result in the maximum power output of the wind turbine and the thermal generator. For a given wind turbine configuration, the optimum resisting torque can be determined for a range of wind speeds from the turbine performance curves and saved in a control system used by the apparatuses discussed herein. Optimal turbine performance and maximum power generation are obtained when the resisting torque of the thermal generator and controller, also known as a viscous controller, is as close as possible to the optimum resisting torque (peak point 300 on FIG. 3B) of the turbine. Therefore, as described further herein, the thermal generator and controller can be configured to include a means of varying the resisting torque as the turbine speed changes. Further, as described further herein, the thermal generator and controller can be configured to include a means of varying the heat generated by the thermal generator. For example, the final generator can be configured such that the gap width “a” of the fluid chamber can be actively controlled to produce the optimal torque for the current wind speed condition or the fluid characteristics can be varied to modify the torque.

FIG. 4A is a cross section of one embodiment of a thermal generator and controller 400A having a shaft 402 and a rotatable inner cylinder 404 mounted inside a stationary outer drum 406. Inner cylinder 404 rotates about axis “A.” In another embodiment, the cylinder is stationary and the outer drum is configured to move or rotate. In the illustrated embodiment, inner cylinder 404 and outer drum 406 have opposing surfaces 404A and 406 A, respectively, that define boundaries of a fluid chamber having a gap 408 filled with a fluid 410, e.g., a thermal fluid. The cylinder 404 and drum 406 are an example embodiment of first and second members having opposing surfaces that together define boundaries of a fluid chamber filled with fluid 410. For example, thermal fluid 410 is shearable fluid, a Newtonian fluid with a linearly predictable fluid property, or a non-Newtonian fluid that has shear thickening properties, e.g., fluid viscosity increases as shear stress increases. In another embodiment, the thermal fluid will be configured to have at least one of the following properties: stable viscosity over a wide operating temperature range, resistance to shearing and thermal breakdown over the fluids useful life, food grade quality, a renewable fluid, and petroleum based. In another embodiment, the drum has a variable wall that can be varied to vary the relationship between the cylinder and the drum.

In the illustrated embodiment, rotation of inner cylinder 404 mounted inside a stationary outer drum 406 having a fluid chamber or gap 408 filled with fluid 410 generates shear stress in fluid 410 and a resisting torque on rotatable inner cylinder 404 that is transferred to shaft 402 of a turbine (not shown) to control turbine speed. Furthermore, the rotation of the apparatus generates heat in fluid 410 that can be transferred to a load, e.g., a water heater. By varying the fluid chamber or gap 408, thermal generator and controller 400A can be configured to vary the resisting torque to control turbine speed and/or configured to vary the heat generated in the fluid.

FIG. 4B illustrates thermal generator and controller 400B having a thermal fluid heat transfer system. The heated thermal fluid 410 in gap 408 is circulated, e.g., pumped, in a fluid flow path from gap 408 through an opening or outlet (not shown) in outer drum 406 to conduit/tubing/piping 412 and to a heat exchanger (not shown) inside a thermal storage tank (not shown) or some other point of use that consumes the heat from the heated thermal fluid 410. The cooled thermal fluid returns in the fluid flow path in conduit/tubing/piping 412 back into gap 408 through another opening or inlet (not shown) in outer drum 406. In the illustrated embodiment, the thermal fluid heat transfer system includes valves 414 to vary the flow rate of thermal fluid 410 to maintain or control the fluid temperature within the thermal generator and/or the temperature of the thermal storage tank (not shown). In another embodiment, one or more than two valves may be included in the fluid system to vary flow in the fluid flow path. In another embodiment, a pump is included in the fluid system and the pump is securedly connected to the turbine shaft, eliminating the need for additional power to run the fluid system. In yet another embodiment, a pump is an electric pump and may include controls to vary the flow rate of the fluid system. In another embodiment, at least one valve and/or a pump are controlled by a control system.

FIG. 4C illustrates thermal generator 400C having a combined thermal fluid and heat transfer fluid system. In the illustrated embodiment, heated thermal fluid 410 is maintained within stationary outer drum 406 and the heat generated by thermal generator and controller or viscous controller transfers from the thermal fluid 410 through outer drum 406 into heat exchanger 416 having heat transfer fluid (not shown) and is further wrapped in insulation 418. In another embodiment, viscous controller may not include insulation. In the illustrated embodiment, heat exchanger 416 is a circular coil heat exchanger that wraps around outer drum 406 and has inlet 416A and outlet 416B that extend in and out, respectively, of insulation 418. Heat exchanger 416 and inlet 416A and outlet 416B are part of a fluid system that defines a fluid flow path from the heat exchanger to a load and back to the heat exchanger. For example, inlet 416A and outlet 416B are connected to conduit/tubing/piping that extends to and returns from a heat exchanger (not shown) inside a thermal storage tank (not shown). In another embodiment, the heat exchanger may be configured as a plate heat exchanger or heat exchange tube that is adjacent to at least a portion of the external surface of the outer drum or member. In yet another embodiment, the heat exchanger may be integrally formed with the outer drum.

In another embodiment, thermal generator includes a control system that includes at least one of the following features: thermal generator monitor, thermal generator control, measures and varies performance parameters such as revolutions per minute and thermal fluid temperature, indicate errors in thermal generator performance (i.e., parameters not in normal operating range), measures and varies fluid speed (e.g., wind speed), measures and varies turbine speed (e.g., revolutions per minute), measures and varies temperature of fluid in fluid chamber, measures and varies resisting torque, measures and varies shear stress of thermal fluid, measures and varies fluid system flow rate and/or temperature, measures and/or varies thermal fluid gap to achieve optimal resisting torque.

FIG. 5 is a thermal generator and controller 500 having a tapered cylinder arrangement connected to shaft 502 of a turbine (not shown). In the illustrated embodiment, thermal generator 500 includes rotatable tapered inner cylinder 504 mounted inside a stationary tapered outer drum 506. Inner cylinder 504 rotates about axis “A.” In another embodiment, the cylinder is stationary and the outer drum is configured to rotate. In the illustrated embodiment, inner cylinder 504 and outer drum 506 are tapered between a first and second end, e.g., top and bottom ends. In the illustrated embodiment, inner cylinder 504 and outer drum 506 have substantially similar tapers. In another embodiment, the inner cylinder and outer drum do not have substantially similar tapers. In yet another embodiment, the outer drum is not tapered.

In the illustrated embodiment, inner cylinder 504 and outer drum 506 have opposing surfaces 504A and 506 A, respectively, that define boundaries of a fluid chamber having a gap 508 having a width “a” filled with a fluid 510, e.g., a fluid or a thermal fluid. The tapered cylinder 504 and drum 506 are another example embodiment of first and second members having opposing surfaces that together define boundaries of a fluid chamber filled with fluid 510.

In the illustrated embodiment, rotation of inner cylinder 504 mounted inside a stationary outer drum 506 having a fluid chamber or gap 508 filled with fluid 510 generates shear stress in fluid 510 and a resisting torque on rotatable inner cylinder 504 that is transferred to shaft 502 of a turbine (not shown) to control turbine speed. Furthermore, the rotation of the apparatus generates heat in fluid 510 that is transferred to a load, e.g., a water or space heater. By varying the fluid chamber or gap 508, thermal generator and controller 500 can be configured to vary the resisting torque to control turbine speed and/or configured to vary the heat generated in the fluid.

For example, tapered outer drum 506 position can be varied, e.g., axially or vertically adjusted, relative to tapered inner cylinder 504 in order to increase or decrease the fluid chamber or width “a” of gap 508 between tapered inner cylinder 504 and tapered outer drum 506. The fluid chamber or gap 508 can be varied in order to actively control the resisting torque generated by thermal generator and controller 500 to control turbine shaft 502 so that the optimum resisting torque and/or maximum power generation (heat generation) can be varied or maximized. By varying the gap, the resistance of the thermal generator and controller or resisting torque applied to the turbine is varied to optimize the power being produced by the turbine (as discussed above in reference to FIGS. 3A and 3B). The power produced by the turbine converts to thermal energy during operation of the thermal generator and controller. The change in resisting torque of the thermal generator and controller or load applied to the turbine is a parameter of the thermal generator devices. This can be referred to as the controller and can control resistance by varying at least one of the following: distance between opposing surfaces of plates or cylinder surfaces, shearing surface area, viscosity of shearing or thermal fluid, and speed of input shaft. Furthermore, the controller will allow for governing and varying the tip speed ratio and allow for use of a variety of turbine types, configurations and sizes.

In another embodiment, the thermal generator and controller may include at least one sensor and an electronic control system to vary one or more parameters of the thermal generator and controller system or a component therein. For example, a first sensor that senses a rotating speed of said input shaft of said turbine and a second sensor that senses a speed of a motive fluid that rotates said turbine and an electronic control system responds by varying the gap between the first member and second member. For a known radius of said turbine, an angular velocity of a tip speed can be determined and included in said electronic control system. In another example, a resisting torque sensor monitors the resisting torque generated by rotation of the thermal generator and controller and an electronic control system responds by varying the gap between the first member and second member (e.g., the inner cylinder and outer drum or opposing plates) to vary the generation of the resisting torque provided to the turbine and/or to vary the generation of the heat provided to the load. In another embodiment, a turbine speed sensor or turbine tip speed sensor monitors the turbine speed and an electronic control system responds by varying the gap between the first member and second member (e.g., the inner cylinder and outer drum or opposing plates) to vary the generation of the resisting torque and/or to vary the generation of the heat in order to vary the speed of the turbine. In yet another embodiment, a temperature sensor monitors temperature of the turbine's motive force or the temperature of the fluid chamber or fluid system and an electronic control system responds by varying the gap between the first member and second member (e.g., the inner cylinder and outer drum) to vary the generation of the resisting torque and/or to vary the generation of the heat in order to vary the speed of the turbine and/or the temperature of the of the fluid chamber or fluid system. In another embodiment, a turbine speed sensor, turbine tip speed sensor, or turbine tip speed ratio sensor monitors the turbine speed and an electronic control system responds by varying the gap between the first member and second member (e.g., the inner cylinder and outer drum) to vary the generation of the resisting torque and/or to vary the generation of the heat in order to vary the speed of the turbine. The electronic control system may be configured to control the turbine speed by seeking an optimum tip speed ratio. In another embodiment, tip speed or tip speed ratio has a range of tip speeds or tip speed ratios where said range is within a percentage of an optimum tip speed ratio, e.g., within 5%, within 10%, within 15%, within 20%, within 25%, within 30%, or within 35%.

The relative position of the first and second members or the inner cylinder and outer drum can be implemented in many ways. For example, in the illustrated embodiment, thermal generator 500 includes linear actuator 512 disposed between a lower portion 506B of tapered outer drum 506 and a lower portion 514A of housing 514. Tapered outer drum 506 is vertically or axially varied relative to inner cylinder 504 by varying linear actuator 512 to expand or contract in axial length. Vertical or axial expansion of linear actuator 512 moves outer drum 506 up or axially towards inner cylinder 504 and decreases the fluid chamber or width “a” of gap 508 between tapered inner cylinder 504 and tapered outer drum 506, thereby increasing resisting torque and increasing power generation of thermal generator 500. Vertical or axial contraction of linear actuator 512 moves outer drum 506 down or axially away from inner cylinder 504 and increases the fluid chamber or width “a” of gap 508 between tapered inner cylinder 504 and tapered outer drum 506, thereby decreasing resisting torque and decreasing power generation of thermal generator 500.

FIG. 6 is a thermal generator 600 having linear viscous dampers 602 securedly connected to crank arms 604 that are securedly connected to shaft 606 of a turbine (not shown). The rotating turbine shaft 606 drive crank arms 604 to activate the linear dampers in and out, producing heat in thermal fluid (not shown) contained in each damper 602 and generating a resisting torque that is applied to turbine shaft 606. Viscous dampers 602 move relative to a stationary housing 602A to generate heat in a fluid contained in a fluid chamber (not shown). Each viscous damper 602 and stationary housing 602A has opposing surfaces that define the fluid chamber or a gap. In the illustrated embodiment, the amount of resisting torque and/or heat generated by thermal generator and controller 600 can be varied by controlling the amount of linear movement of each damper or by varying the amount of thermal fluid. As discussed herein, thermal generator 600 may include either a thermal fluid heat transfer system or a combined thermal fluid and heat transfer fluid system to capture the heat generated during operation. In another embodiment, thermal generator may include sensors discussed herein, a control system as discussed herein, or any number of dampers.

FIG. 7 is a thermal generator and controller 700 having a stacked disk or disk pack arrangement connected to shaft 702 of a turbine (not shown). In the illustrated embodiment, thermal generator 700 includes a plurality of rotatable plates 704 attached to shaft 706 that rotates about axis A and non-rotatable plate 708 are securedly fixed to outer drum 710 and radially extend towards shaft 706. Rotatable plates 704 and non-rotatable plates 708 are staggered axially so they are axially opposed. In the illustrated embodiment, the rotatable plates and non-rotatable plates are in an alternating arrangement relative to each other, i.e., rotating plate, non-rotating plate, rotating plate, etc. Shaft 706 is securedly connected to shaft 702. In another embodiment, these shafts could be one shaft or multiple interconnected shafts. Each plate has shearing surface area on one or both sides and the amount of resisting torque and related heat can be configured by the number of plates and the size of the shearing surface area on each plate. In another embodiment, more than one non-rotatable plate or more than one rotatable plate may be adjacent to each other. In another embodiment, the number of rotatable plates and number of non-rotatable plates varies from what is shown in the illustrated embodiment. In yet another embodiment, the drum and the corresponding connected plates rotate and the shaft and the corresponding connected plates are stationary.

In the illustrated embodiment, thermal fluid 712 fills gap 714 having a width or height of “a” between rotatable plate 704 and non-rotatable plate 708 that can vary depending on plate position in thermal generator and controller 700. In the illustrated embodiment, rotatable plates 704 and non-rotatable plates 708 have opposing surfaces 704A and 708A, respectively, defining boundaries of a fluid chamber having a gap 714 having a width “a” filled with a fluid 712, e.g., a fluid or a thermal fluid. The rotatable plates 704 and non-rotatable plates 708 and drum 710 are another example embodiment of first and second members having opposing surfaces that together define boundaries of a fluid chamber filled with fluid 712.

In the illustrated embodiment, rotation of rotatable plates 704 and shaft 706 mounted inside stationary drum 710 having a fluid chamber or gap 714 filled with fluid 712 generates shear stress in fluid 712 and a resisting torque on rotatable plates 704. This resisting torque is transferred to shaft 702 of a turbine (not shown) to control turbine speed. Furthermore, the rotation of the apparatus generates heat in fluid 712 that is transferred to a load, e.g., a water heater or the like. By varying the fluid chamber or gap 714, thermal generator and controller 700 can be configured to vary the resisting torque to control turbine speed and/or configured to vary the heat generated in the fluid.

Non-rotatable plates 708 and outer drum 710 are vertically or axially varied relative to rotatable plates 704 and shaft 706 by varying hydraulic piston 716 to expand or contract in axial length. In the illustrated embodiment, there are a plurality of hydraulic pistons 716. In the illustrated embodiment, vertical or axial expansion of hydraulic pistons 716 move outer drum 710 and non-rotatable plates 708 up or axially towards rotatable plates 704 and decreases width “a” of gap 714 between rotatable plates 704 and the lower non-rotatable plates 708, this increases resisting torque to turbine shaft 702 and increases power generation of thermal generator and controller 700 that can be transferred to a load. Vertical or axial contraction of hydraulic piston 716 moves outer drum 710 and non-rotatable plates 708 down or axially away from rotatable plates 704 and increases width “a” of gap 714 between rotatable plates 704 above the non-rotatable plates 708, this decreases resisting torque to turbine shaft 702 and decreases power generation of thermal generator and controller 700 that can be transferred to a load. In another embodiment, other control mechanisms can be used to control the vertical or axial position of outer drum 710 and non-rotatable plates 708 relative to rotatable plates 704, including but not limited to actuators and springs that vary movement of rotatable and non-rotatable disks relative to one another. As discussed herein, varying the vertical axis position of the outer drum enables active control of the thermal generator and controller's resisting torque to match the optimal wind turbine performance curve and therefore produce an optimum amount of thermal energy that can be used by the loads and systems discussed herein. e.g., the heated or thermal fluid can be circulated to a storage tank or alternately a separate heat exchanger could be mounted inside or next to the controller.

FIGS. 8A-8F illustrate an example where the schematic illustrated in FIG. 7 can be implemented in a physical embodiment in a thermal generator and controller having a stacked disk or disk pack arrangement. FIG. 8A illustrates an exploded view of a portion of thermal generator 800 including housing 802 having teeth/splines 804 axially extending along inner surface 806 of housing 802. Axially extending teeth/splines 804 allow plates to move vertically or with one degree of freedom. Further illustrated is input shaft 808 that is configured to securedly connect to turbine shaft (not shown). Input shaft 808 transfers motive force or power from the turbine to thermal generator 800 and transmits resisting torque from the controller to the turbine shaft. Input shaft 808 is fixed to housing 802 by bearings (not shown), both at top and bottom of housing 802, allowing input shaft 808 to rotate relative to housing 802. In another embodiment, input shaft is configured to move axially or vertically up and down between two set points to engage the disc pack or to engage the plates securedly connected to the housing. In yet another embodiment, input shaft is fixed in the axial or vertical direction and an internal actuator (not shown) activates the disc pack for actuation of the gap distance. In the illustrated embodiment, input shaft 808 uses stops (not shown) at both top and bottom of the splined area of housing 802 to constrain plates during actuation of the disk pack.

As illustrated in FIG. 8B, input shaft 808 sets into a lower position in housing 802 in a lower bearing (not shown) that allows for rotatable plates 810 and non-rotatable plates 812 to be positioned along input shaft 808. Rotatable plates 810 and non-rotatable plates 812 assembled on an input shaft form a disk pack. The surface areas of the rotatable plates 810 and the non-rotatable plates 812 are the shearing surface areas of the disc packs. Non-rotatable plates 812 have teeth 814 that engage with splines that prevent rotation and fix to housing 802. Rotatable plates 810 have teeth 816 that are fixed to and rotate with input shaft 808. These plates all have one degree of freedom within the device, e.g., an axial or a linear direction. In another embodiment, a thrust bearing (not shown) is assembled at the bottom and top of the rotating plates (i.e., the disk pack) to allow pressure to be applied via an actuator to compress plates.

In the illustrated embodiment, plates 810 and 812 are separated from each other by an interposed wave spring 816. FIG. 8C illustrates a top view and a side view of an exemplary embodiment of a wave spring. In another embodiment, another spring design or another compressible fastener may be used or the wave springs can have different spring rates to allow a progressive nonlinear resistance output. The wave springs that separate the plates (810, 812) allow the plates to actuate axially when applying a load in an axial motion and provides the mechanism for which the variation of gap distance between plates can be varied. In the illustrated embodiment, non-rotatable plates 812 have central holes 812A that are configured to accept adjacent wave springs 816 so the there are no frictional effects on the non-rotatable plates. For example, the central holes 812A in non-rotatable plates 812 are larger to receive the wave springs, wherein the smaller holes in the rotatable plates 810 will not receive the wave springs and the wave springs therefore act upon the rotatable plates.

As illustrated in FIG. 8D, input shaft 808 further includes constraint ring 818 and thrust bearings 820 that hold plates (810, 812) in place in the disk pack. Disk pack 822 is securedly connected to housing 802 as illustrated in FIG. 8E and housing 824 includes a sealed bearing (not shown) to support input shaft 808 connected to housing 802 as illustrated in FIG. 8F. The heat generated in the thermal fluid inside thermal generator 800 is dissipated when it is transferred from the thermal generator using a heat transfer fluid system discussed herein.

In another embodiment, thermal generator includes an actuator to compress the disc pack plates. In one embodiment, an external actuator axially moves input shaft to compress the plates or to reduce the gap between the plates as discussed herein. A thermal generator includes an internal actuator that applies pressure to a thrust bearing on either the top or bottom portion of the input shaft (or both portions) to compress the plates. For example, internal actuation mechanism includes an actuator input plate, actuator balls, and an actuator output plate used to apply the force and actuation to at least one thrust bearing.

FIG. 9 illustrates a turbine thermal generator and controller system 900 incorporating at least one thermal generator and controller (viscous controller) to vary the resisting torque to control turbine speed and/or to convert the mechanical work from the rotating turbine to thermal energy to heat water and the like in a home, business, or other point of use. The system 900 includes viscous controller 902 connected to turbine 904. Heat generated from thermal generator and controller or viscous controller 902 is transferred to a fluid through a fluid system, e.g., the thermal fluid or another heat exchange fluid. Specifically, fluid system includes a pump 908 that circulates this fluid in lines/tubing/piping 906 to at least a first heat exchanger 910 where the heat generated by viscous controller 902 is transferred to the load (e.g., a home, business, water heating system, space heater, and the like).

In one embodiment, the pump is driven by the turbine shaft and pumps the fluid when the turbine rotates. In another embodiment, the pump is the viscous controller. In another embodiment, the pump is an electric pump and can vary the flow rate by changing pumping speed using a control system and the like. In one embodiment, the heat is transferred to and carried through the fluid system by a fluid that is approved by a food and drug agency.

Returning from the load, the fluid (e.g., cooler thermal fluid or cooler heat exchange transfer fluid) flows to thermal generator 902 in lines/tubing/piping 906 for another heat transfer cycle. In another embodiment, turbine thermal generator and controller system includes a solar thermal collector (e.g., a solar panel) as an additional source of heat that is added to the load or system, e.g., when there are low periods of turbine energy (e.g., winds, tides, and the like). In another embodiment, turbine thermal generator system includes at least one sensor and an electronic control system that includes at least one of the following features: thermal generator monitor, thermal generator control, measure and record performance parameters such as revolutions per minute and thermal fluid temperature, indicate errors in thermal generator performance (i.e., parameters not in normal operating range), measure fluid speed (e.g., wind speed), measure turbine speed (e.g., revolutions per minute), measure thermal fluid temperature in at least one location of system, and measure and/or vary thermal fluid gap to achieve optimal resisting torque or maximum power extraction range. In one embodiment, power for the control system is provided by a coil or a simplified generator placed on the input shaft to supply a electrical power

FIG. 10 illustrates another embodiment of a thermal generator and controller 1000 securedly connected to turbine shaft 1002 and further including a self-starting motor 1004 that is powered by a battery 1006. The motor can be mounted either directly on the shaft or next to the shaft and coupled with a belt/chain or gear configuration. Self-starting motor 1004 is used to help “push” start the turbine shaft 1002. In another embodiment, the turbine shaft is pushed to start by pressurized gas or another fluid. In yet another embodiment, the motor can act as a generator to charge the battery.

The embodiments of this invention shown in the drawings and described above are exemplary of numerous embodiments that may be made within the scope of the appended claims. It is contemplated that numerous other configurations of the turbine thermal generator and controller may be created taking advantage of the disclosed approach. For example, any one or more of the parts of each embodiment may be used in combination with any one or more of the parts of another embodiment. In short, it is the applicant's intention that the scope of the patent issuing herefrom be limited only by the scope of the appended claims.

What is claimed is:

1. An apparatus comprising:
first and second members having opposing surfaces together defining boundaries of a fluid chamber;
means for rotating about an axis said first member relative to said second member thereby generating heat in a fluid contained in said fluid chamber; and
means for transferring heat from said fluid to a load.

2. The apparatus of claim 1, wherein said apparatus includes a means for moving said first and second members relative to one another along said axis thereby varying generation of said heat in said fluid.

3. The apparatus of claim 2, wherein said apparatus further comprises an inlet into said fluid chamber and an outlet out of said fluid chamber, and wherein said means for transferring heat from said fluid to said load is a fluid system that defines a fluid flow path from said outlet to said load and from said load to said inlet.

4. The apparatus of claim 3, wherein said fluid system includes a heat exchanger in a heat transferring relationship with said load.

5. The apparatus of claim 2, wherein said means for transferring heat from said fluid to said load is a fluid system having a first heat exchanger in a heat transferring relationship with said second member, wherein said fluid system defines a fluid flow path from said first heat exchanger to said load and from said load to said first heat exchanger.

6. The apparatus of claim 5, wherein said first heat exchanger is a heat exchange tube.

7. The apparatus of claim 5, wherein said fluid system further comprises a second heat exchanger in a heat transferring relationship with said load.

8. The apparatus of claim 2, wherein said first member is a cylinder and said second member is a drum.

9. The apparatus of claim 2, wherein said fluid is a shearable fluid.

10. The apparatus of claim 2, wherein said first member comprises a plurality of first plates securedly connected and radially extending from a shaft and said second member comprises a plurality of second plates securedly connected and radially extending from a drum towards said shaft of said first member.

11. The apparatus of claim 1, wherein said means for transferring heat from said fluid to said load is a fluid system having a solar thermal system for generating heat for said load.

12. An apparatus comprising:
a turbine having an input shaft and an output shaft;
first and second members having opposing surfaces together defining boundaries of a fluid chamber;
means for rotating about an axis said first member relative to said second member thereby generating a resistance in a fluid contained in said fluid chamber;
means for transferring said resistance to said turbine as a resisting torque;
a first sensor that senses a rotating speed of said input shaft of said turbine and a second sensor that senses a speed of a motive fluid; and
means for responding to said sensors by moving said first and second members relative to each other along said axis thereby varying generation of said resisting torque.

13. The apparatus of claim 12, further comprising means for controlling said rotating speed of said output shaft in response to said means for sensing said rotating speed of said input shaft.

14. The apparatus of claim 13, wherein said rotating speed of said input shaft is a tip speed ratio.

15. The apparatus of claim 14, wherein said turbine has a range of tip speed ratios including an optimum tip speed ratio, and wherein said means for controlling a speed of said turbine seeks said optimum tip speed ratio.

16. The apparatus of claim 15, wherein said range of tip speed ratios is within 25% of said optimum tip speed ratio.

17. The apparatus of claim 15 further comprising a control system that measures a temperature of said fluid contained in said fluid chamber.

18. The apparatus of claim 12, wherein said first member is a cylinder and said second member is a drum.

19. The apparatus of claim 12, wherein said first member has a plurality of first plates radially extending from a shaft and said second member has a plurality of second plates securedly connected to a drum.

20. An apparatus comprising:
first and second members having opposing surfaces together defining boundaries of a fluid chamber;
means for moving said first member relative to said second member thereby generating heat in a fluid contained in said fluid chamber;
means for transferring heat from said fluid to a load; and
a turbine in communication with a motive force.

21. The apparatus of claim 20, wherein said apparatus includes a means for moving said first and second members relative to one another thereby varying generation of said heat in said fluid.

22. The apparatus of claim 20, wherein said turbine includes an output shaft and said apparatus includes a pump connected to said output shaft.
